(19) United States
(12) Patent Application Publication
(10) Pub. No.: US 2018/0262891 A1
(43) Pub. Date: Sep. 13, 2018

(54) ELECTRONIC ACCESS CONTROL SYSTEMS AND METHODS USING NEAR-FIELD COMMUNICATIONS, MOBILE DEVICES AND CLOUD COMPUTING

(71) Applicant: 3M INNOVATIVE PROPERTIES COMPANY, St Paul, MN (US)

(72) Inventors: Shuguang Wu, Austin, TX (US); Jun Xiao, Austin, TX (US)

(21) Appl. No.: 15/573,843

(22) PCT Filed: Jun. 2, 2016
(86) PCT No.: PCT/US16/35437

§ 371 Date: Nov. 14, 2017

Related U.S. Application Data
(60) Provisional application No. 62/174,109, filed on Jun. 11, 2015.
(60) Provisional application No. 62/287,612, filed on Jan. 27, 2016.

(51) Int. Cl. H04W 4/80; G07C 9/00; H04L 29/06; H04W 12/04; H04W 12/06

(52) U.S. Cl. CPC H04W 4/80; G07C 9/00309; H04L 63/0492; G07C 2009/0042; H04W 12/06; G07C 9/00571; G07C 9/00857; H04W 12/04

(57) ABSTRACT

Systems and methods for electronic access control for secured assets including locked facilities, lockers, shared vehicles and vending machines, which do not have internet connectivity. A mobile device communicates with a server to perform the authentication and access control steps, limiting the asset's interactions with outside devices to exchanging and updating access codes via short-range communications, such as near-field communications. Authentication and access control steps may be performed when the mobile device is at the secured asset, or alternatively those steps may be performed in advance, to allow access to assets located outside of data service to the mobile device.

### BACKGROUND

Physical access control refers to the selective restriction of access to a place or object, and access may include use of some of the functions of an object, or be mediated by transactions governing access to the content of an object. Electronic access control systems and methods are used to overcome the limitations of mechanical locks and keys and providing the control over who, where and when access is granted. In a typical access control system, the user presents a credential to an intelligent reader which compares the credential's information against an access control list before granting or denying the access request. The credential could be something that the user “knows” (password or PIN); “has” (key fob or tag inside a phone) or “is” (fingerprint or iris scans). The intelligent reader needs to access the access control list (database) which is either stored locally or in a server that is connected with the reader. To ensure correct access control, the list needs to be kept up to date when access level of a user has been changed (revoked or granted), either through communication network or local update.

### SUMMARY OF THE INVENTION

Embodiments of the invention include methods and systems for smart phone, near field communication (NFC) and cloud based access control wherein the architecture eliminates the need for network connectivity at the secured asset (e.g. an industrial cabinet, a shared vehicle, or a vending machine), offers security enhancements, and computationally simplifies the operations that need to be performed at the locking unit, reducing the cost and power draw of the locking unit. Since the secured asset is not connected to the Internet and the unlocking mechanism requires physical proximity, the system is inherently more secure compared to most existing “smart lock” and other networked systems that allow remote access. The multi-factor authentication process further enhances the security through token-based verification between smart phone and central server and verification of the user as well as verification of the key device, and more robust generation of passwords by allowing the passwords to be completely randomized. Besides being networking-free at the locking unit, the lock control logic according to this architecture is computing and storage efficient, enabling low cost design and low-power operation. In some embodiments, the low-power nature of operation of this architecture is leveraged by using energy harvesting from the mobile device to operate the electronics, eliminating the need for a local power source within the lock.

### DESCRIPTION OF THE DRAWINGS

FIG. 1A is the system architectures for an example embodiment system of this invention where the locking mechanism is powered by storage or sources at the locking unit.

FIG. 1B is the system architecture for an example embodiment system of this invention where the locking mechanism relies on power harvested from the mobile device through near-field communications.

FIG. 2 is a diagram of the sequence of events in an access request in an embodiment of this invention.

FIG. 3 is a diagram of the process flow for an access request in an embodiment of this invention.

FIG. 4 is a system diagram of an embodiment of the invention applied to controlling access to a vending machine.

FIG. 5 is a diagram of an embodiment of the invention applied to controlling access to a shared vehicle.

FIG. 6 is a process flow diagram for controlling access to a vending machine.

FIG. 7 is a process flow diagram for controlling access to a shared vehicle.

### DETAILED DESCRIPTION OF THE INVENTION

Electronic locking and access control provide many advantages in terms of dynamic, secure access to particular assets and their various functions along with convenience in management and deployment. Improved architectures for such locking and access control can expand the application of these access control methods, by reducing computational and power demands through efficient allocation of tasks to mobile devices and cloud computers, and remove risks of remote hacking or other attack by enabling access control systems where the locking units do not need to directly communicate with the wider world, instead only requiring local communications with a mobile device. System architectures that efficiently allocate the computing tasks required for authentication, code management, and determining access authorizations provide more efficient, more secure and more widely applicable electronic access control systems which require less power and feature fewer opportunities to break codes or hack into locking units. In particular, these advantages may be valuable for application in utility cabinets and at secured utility locations such as transformer banks and substations, where security is a significant concern and the secured locations may have limited access to power for operating the locking unit.

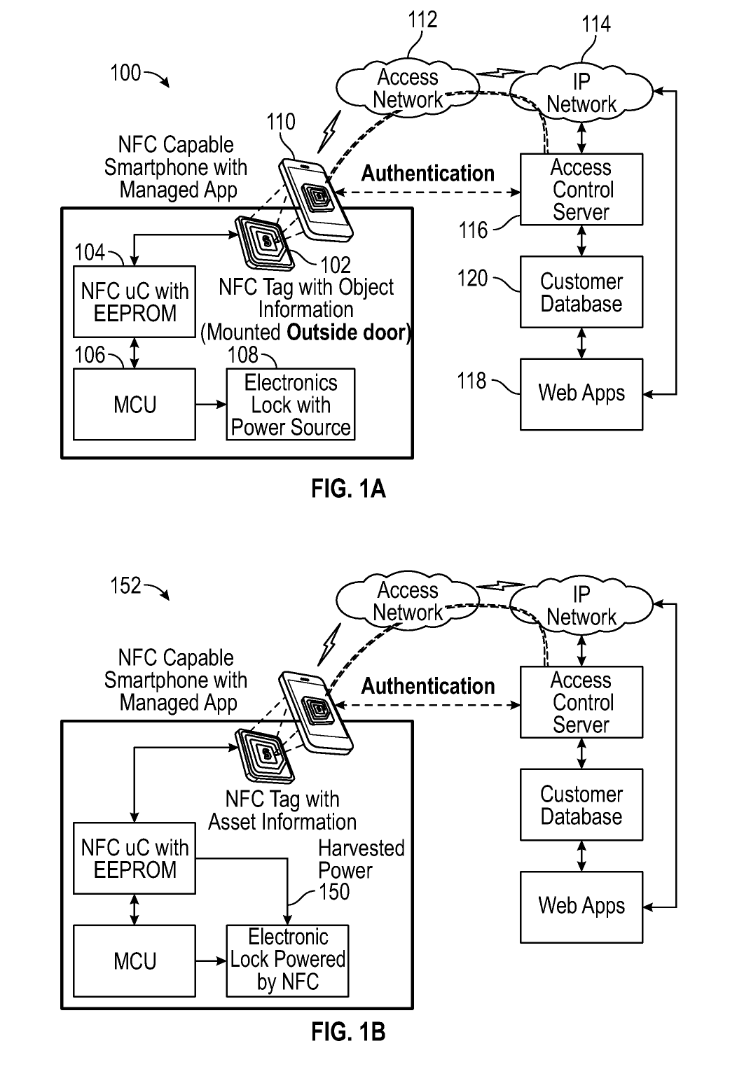

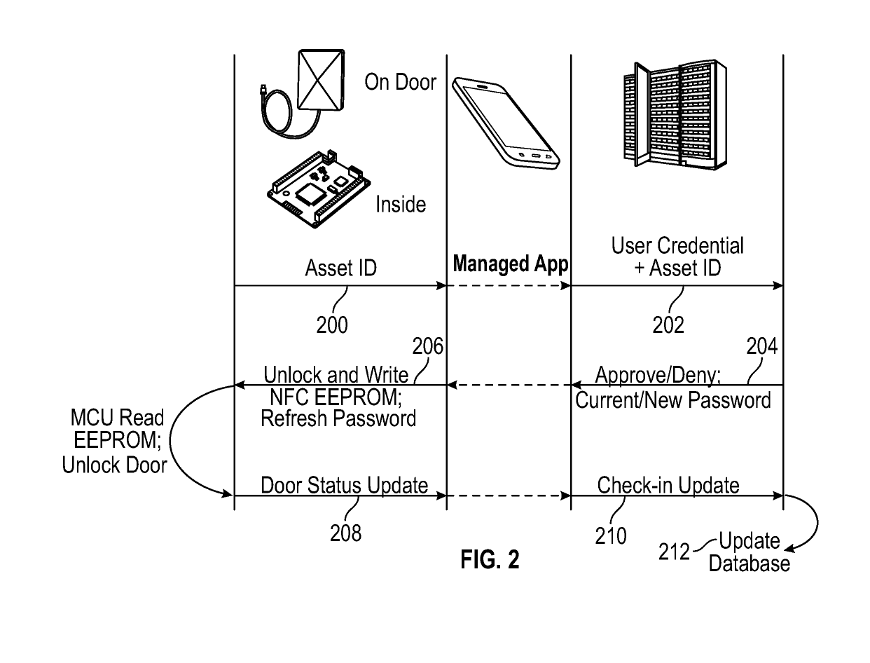

The architecture of an example embodiment of the invention is presented in FIG. 1A and FIG. 1B, including locking unit 100, mobile device 110, which connects through access network 112 and IP network 114 to connect with server 116, customer database 120, and optionally with web apps 118.

In this example embodiment, locking unit 100 has sub-components of a near-field communications (NFC) tag 102, an NFC microchip and non-volatile memory 104, microcontroller 106, and lock actuator 108 and 152. The locking unit may control access to a physical location such as a utility cabinet or access doors at facilities, or may control access to parts of an asset such as the contents of a vending machine, or may control access to a shared asset such as a shared vehicle, for example by controlling the door locks and/or the ignition of the shared vehicle. The components of the locking unit may all be within one housing. In preferred embodiments, the locking units do not include connections to networks except for the NFC tag. In some embodiments, the locking unit contains a power storage such as a battery connected to the lock actuator 108 to provide it with power for locking and unlocking operations. In other embodiments, the locking unit can draw power from a source such as a wall outlet, for example for embodiments where the locking unit controls access to a vending machine.

The locking unit in this example embodiment includes an NFC Tag with an embedded antenna 102, which is mounted outside the locking unit, such as on the surface of a door that is secured by the locking unit. The locking unit 100 includes an NFC chip with an embedded nonvolatile memory 104. The NFC chip 104 is coupled to NFC tag 102 and is capable of interpreting the data communicated to the NFC tag. The NFC chip 104 stores a locking unit identification number which can be read by other NFC devices connecting to the tag, for example mobile devices with NFC antenna that are brought into close proximity with the tag. In some embodiments, a mobile device 110 initiates a connection with a NFC tag 102 through physical contact with the NFC tag, such as tapping the tag with the device. In some embodiments, the NFC Tag 102 and NFC chip 104 may be substituted with other means for short-range wireless communications with another device, for example Bluetooth or RFID, or optical communications techniques.

The non-volatile memory is a memory configured to store the current access code, which may be, for example, a random alphanumeric string. The non-volatile memory may, in some embodiments, be able to be read-protected and write-protected to prevent unauthorized access and overwriting of the stored current access code. In a preferred embodiments, this non-volatile memory is EEPROM. Optionally, the memory may be configured to store multiple access codes, for example having one dynamic access code, having a second segment of the memory storing the dynamic access code again as a backup in case of failures in reading or writing to the memory, and optionally having a third segment of the memory store a master access code that also grants access.

NFC chip 104 is configured to compare an access code received through the NFC tag 102 with a current access code stored in the non-volatile memory embedded in the NFC chip 104. If those access codes match, the NFC chip 104 sends a signal to the microcontroller 106, for example by writing a unique data pattern into a predefined location in the non-volatile memory. The microcontroller has access to the non-volatile memory through a data bus such as I²C. The microcontroller 106, based on the unique data pattern, communicates a signal to an actuator for a locking mechanism 108 or 152 for the secured asset. In some embodiments, the locking mechanism may govern access to a particular chamber of a secured asset (for example, in some vending machine embodiments), or may control use of the asset (for example, the doors and/or ignition in shared vehicle embodiments). In some embodiments, the NFC chip 104 may activate or deactivate write-protection on the nonvolatile memory 104 to allow the memory to be overwritten, for example to replace a current access code with an update code which becomes the access code for a subsequent unlocking attempt. In some embodiments, the microcontroller 106 could be replaced by using an NFC chip 104 where the NFC chip can itself assert an I/O pin when the proper credential is presented.

The locking unit may additionally, optionally include sensors and logging units for those sensors to capture environmental conditions at the asset secured by the locking unit. The environmental sensors include, for example, sensors measuring humidity or temperature, and sensors determining the door status (open/close) and/or lock status (locked/unlocked). The logging units are memories that store the data from the environmental sensors. In some embodiments, the sensors and logging units in the locking unit may capture operational data, for example in embodiments where the locking unit controls access to a shared vehicle, the logging unit receives from the car computer information on miles traveled during a use, and stores that information. Operational data collected and logged at the locking unit could also, for example embodiments where the locking unit controls access to the contents of a vending machine, for example sales rates for particular items at that particular machine.

Optionally, and as shown in FIG. 1A, the locking unit may include an actuator for a locking mechanism 108 that is powered by storage as a battery or a source such as a connection to an outside power source.

As shown in FIG. 1B, the locking unit may optionally further comprise an NFC power harvesting unit 150 at the NFC tag, and the actuator for the locking mechanism 152 is powered by the harvesting unit 150 as opposed to an internal energy storage at the locking unit or connection to a power source. In these embodiments, the locking mechanism actuator is preferably a low-power actuator such as a piezoelectric actuator. In these embodiments, the lock may not include an internal power source, instead using solely the power harvested through the NFC unit to power the operations by the microcontroller, the actuation of the lock, and the operations of the NFC microchip and the non-volatile memory.

Mobile Device 110 may be, for example, a smart phone, wearable computing device such as near-to-eye displays or wrist-mounted computing devices, tablets, or custom devices having the components described below for collecting authentication information and communicating with a server via a mobile access network and communicating with a locking unit through short-range wireless communications such as near-field communications, Bluetooth, RFID, or optical, communications. Mobile device 110 may include interfaces or device features through which it can collect authentication information from the particular user of that device, for example a user interface allowing the input of a password or personal identification number (PIN), a fingerprint scanner, or a camera for taking iris images or facial pictures to use as authentication data to verify the identity of the user of the mobile device. The mobile device could include a near-field communications antenna. In some embodiments, the near-field communications antenna is suitable for use with NFC power-harvesting hardware. In some embodiments, a separate antenna is suitable for use with NFC power-harvesting hardware. The mobile device further includes an antenna to transmit and receive data from an access network such as a cellular data network such as a 3G, 4G or LTE network.

Access Network 112 is a network that the mobile device communicates with to access the IP Network 114. The access network may be a cellular data network such as 3G, 4G or LTE. The IP network 114 is a wide area network such as the Internet that enables a connection to the server 116.

Server 116 received the information provided by the mobile device through the Access Network 112 and the IP Network 114. The server includes memories and processors to, for example, validate user authentication requests by receiving user authentication information and comparing the received information to a database of valid user authentication information, or determining whether to allow or deny an access request to a particular locking unit by comparing the device identification, user authentication, date, time, and locking unit asset identification to a database of access rules. In some embodiments, the database of access rules is a reservation schedule, for example to identify the time during which a user has reserved a shared vehicle, to authenticate not only the user but the particular use of the secured asset. In some embodiments, the server may include memories, processors and communications interfaces to access and manipulate account data or to initiate transactions with other parties such as payment processors. For example, in embodiments directed to vending machines, the information received through the Access Network 112 and IP Network 114 may include account information for the user to enable Server 116 to link the user with a transaction and manipulate the account to reflect the debit or credit resulting from the transaction. The server 116 may also manipulate account information during check-out procedures at some secured assets, for example to update a log of maintenance visits to a secured site, or to log the number of miles traveled or current location of a shared vehicle to which access is controlled by embodiments of the invention. In some examples, such as controlling access to vending machines, the Server 116 may additionally trigger a payment process with, for example, a credit card, and require the payment to be resolved prior to evaluating the access request or granting access to the secured asset.

Web Apps 118 may be used in some embodiments of this invention to manage particular data or interactions, such as the server 116 accessing the customer database to authenticate users or to determine acceptance or denial of access requests. The web apps 118 or the server 116 may use a processor to generate an access code, for example through generation of a random string. The web apps may support interaction with the secured asset, for example in some embodiments enabling selection of items in a vending machine, placing a pin on a map representing the location of a shared vehicle to be accessed, logging the location of a check-out from a shared vehicle by accessing GPS data on a mobile device, or storing and controlling payment or account information relevant to the interaction with the secured asset, such as an account with a vehicle-sharing company.

Customer database 120 is a non-volatile memory storing a database of authentication means and permissions rules including information such as approved users, schedules of reservations for use of secured assets, which may be accessed by system users to dynamically update permissions and authentication information, and in some embodiments may also include account information such as reservation schedules, payment or billing information, logs of travel, check-in and check-out times at secured assets, or other information regarding access to, use of, or payment for use of the secured assets. The customer database is accessed by the server 116 for making determinations regarding access requests and optionally to authenticate users. The customer database 120 may be located at the server 116 or remote from it and accessed by the server through the IP network 114.

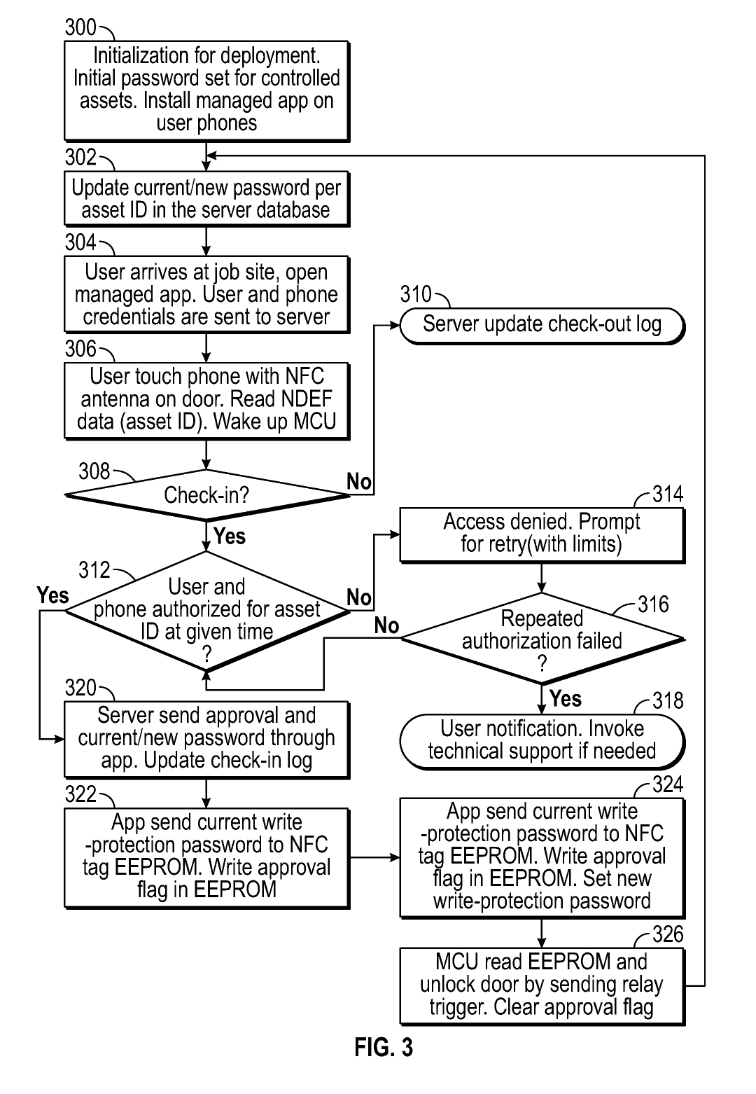

The order of events at various components during an access request according to an example of the invention is laid out in FIG. 2. An asset identification is provided to a mobile device by a locking unit 200. The asset identification, along with user identification information is provided to a server in step 202, which makes an access/deny determination and provides a current access code and an update code to the mobile device in step 204. The mobile device presents the current access code to the locking unit, and if the current access code is correct, the locking mechanism is actuated to allow access and access to the memory is granted to replace the current access code stored at the locking unit with the update code in step 206. A status update is transmitted to the mobile device by the locking unit in step 208, then the mobile device transmits a status update to the server in step 210, with the server updating a database in step 212 based on the status update. In this process, communications between the mobile device and the lock are accomplished through near-field communications, while communications between the mobile device and the server are accomplished through an access network and an IP network, for example a wireless mobile network such as 3G or 4G connecting the mobile device to the internet.

A near-field communications link is established between the mobile device and the locking unit, at which point the locking unit provides its asset identification to the mobile device in step 200. The near-field communications link is initiated by the mobile device being in proximity to an NFC tag on the locking unit, in some examples by tapping the mobile device against the NFC tag of the locking unit. Optionally, the locking unit may be in a dormant state until the NFC tag is contacted by a nearby mobile device. The asset identification is a piece of data sufficient to identify the particular locking unit, secured asset, or a type of requested item from the secured asset (for example, a particular type of soda contained in a vending machine) in databases storing access rules and access codes associated with particular locking units. This may be a numeric or alphanumeric string, for example.

The mobile device collects a user credential and transmits the asset identification and the user credential to the server in step 202. The user credential is a piece of data supplied by the user that identifies the current user of the mobile device. Examples of the kinds of user credentials that a mobile device may collect to authenticate the user a personal identification number (PIN) input into the mobile device through a user interface, a biometric such a fingerprint scan collected by a scanner incorporated into the mobile device or an image of the user's iris captured through a camera on the mobile device, or a picture of the user to be reviewed by facial recognition software. The user credentials may also include things like payment information, for example through mobile payment software, or account information, for example logging into one's membership with a vehicle-sharing program. The managed app may manage the collection of the user credential by providing the interface for PIN input, activating the fingerprint scanner on the mobile device, or controlling the use of the mobile device's camera for capturing the iris image or facial image. The credential and the asset identification are transferred to the server using mobile communications networks such as 3G or 4G and through the connection to the internet provided through that network.

The server makes an access/deny determination and, if access is granted, transmits the current access code and an update code to the mobile device in step 204. The server makes the access/deny determination based on the user credential, the locking unit device identifier, and optionally an identifier for the mobile device. The determination is based on access rules that define users and particular locking units those users may access, and may additionally be based on additional factors such as date and time restrictions on access to particular locking units, reservations for particular assets such as shared vehicles, requirements for particular users to only use particular mobile devices, or made contingent on payment, for example for items secured in a vending machine. In the case of an “access” determination, a current access code and an update code are provided to the mobile device. The current access code is determined, for example, by querying a database that stores the current access codes for each locking unit, using the device identifier for that locking unit or the identification of the secured asset to be provided in response to the access request. The update code is an access code that will replace the current access code. The update code may be generated through a variety of means, but preferably is generated randomly. In some embodiments, the current access and update codes may be encrypted at the server before transmission to the mobile device.

The access and updated codes are transmitted from the mobile device to the secured asset via NFC and, if the access code is correct, the locking unit grants access to the asset and the update code replaces the current access code in step 206, becoming the access code for the next asset request. Granting access may, for example, take the form of unlocking the doors to a vehicle and allowing the ignition to be operated, to unlocking a gate or door to allow access to a secured area, or providing a particular item that was stored within a vending machine. The current access code provided by the mobile device is compared to the current access code stored on non-volatile memory at the secured asset. If the codes do not match, access is not granted. If the codes do match, access is granted. For example, for locks restricting access to secured areas, the lock mechanism actuator is operated to grant access to the secured area. In addition to granting access to the secured asset, the mobile device is given access to the non-volatile memory of the locking unit and the current access code is overwritten with the update code. The actuation of the lock mechanism and the access to memory and overwriting of the current access code may be done sequentially or simultaneously and if sequentially, in any order.

A status update is transmitted from the locking unit to the mobile device in step 208. The status update transmitted from the locking unit to the mobile device may be a confirmation of the unlocking and the updating of the current access code by overwriting it with the update code. The status update may include additional information, such as a confirmation of the update code that has overwritten the prior current access code, time-stamp data for the check-in according to the locking unit, or other such information. It may also include information from environmental sensors that are additionally located at the locking unit, for example temperature data from a temperature sensor, to provide environmental feedback on conditions at the secured asset. It may include information from the door and/or lock sensor that confirms the status of the door (open/close) and/or the lock (locked/unlocked) at the time. The data may be recorded at the time of check-in or check-out at the locking unit, or optionally the sensors may connect to a logging unit including a memory, also located at the locking unit, which may collect the data from that sensor over a period, and with the logged data being included in the information sent to the mobile device for communication to the server. The status update may also include other characteristics of the secured asset, such as the inventory of vending machines, the location a shared vehicle has been left at, mileage update or maintenance alerts from shared vehicles or other data collected at the secured asset.

The mobile device transmits the status update to the server in step 210 and the status update is used to update a database in step 212. The mobile device may update or add further information to the status update it received in step 208 to produce the status update it provides to the server in step 210. The information added to the status update may include, for example, information such as confirmation of the user identification information, time-stamp data for the access operations, device identifiers for the mobile device or the locking unit involved in the unlocking information. The information may also include payment status, for example cash payments at a vending machine, or payment information for a transaction which access may be dependent on. The information may also be specification of a particular type of interaction with the secured asset, such as requesting a particular item from a vending machine. This information is used to update databases connected to the server in step 212, including updating the current access code for the particular locking unit that was accessed, since the current access code was overwritten with the update code. The database updating may also include updating access logs recording who accessed what assets at what time, for example.

During the unlocking process, the locking unit may optionally be harvesting power from the mobile device via the NFC tag. This power harvesting may begin at any time during the process from the initiation of the near-field communications connection between the mobile device and the locking unit, and is preferably initiated at that time so that the time taken to harvest sufficient power to operate the locking mechanism actuator overlaps with the time during which the locking unit, mobile device, and server are communicating to determine access permissions.

Following access to an asset, there may optionally be an additional check-out process conducted using the locking apparatus, the mobile device and the server. This check-out process may include over-writing the current access code with the update code in the memory at the locking unit, and optionally may also include confirmation of closing and re-locking the asset, recording a check-out timestamp, and communicating information regarding the interaction with the lock with the server, for example sending check-in as well as check-out timestamps to the server to log the duration of the access. Check-outs may also include recording the readings of additional sensors at the locking unit, such as sensors indicating the open/closed and locked/unlocked status of the locking mechanism, or environmental factors such as temperature readings at the location of the locking unit, or in embodiments directed towards shared vehicles, vehicle status information such as mileage, maintenance alerts and/or the location of the vehicle.

In some embodiments, the steps may be separated in time or adjusted in order to enable use of this method for access to secured assets that lie outside of mobile data networks and to enable locking units to be used to secure assets that lie outside of mobile data networks. In these embodiments, for example, the collection of user authentication information in step 202 is performed before the mobile device is brought within proximity of the locked asset 200. In those embodiments, device identifiers may be provided by an outside source, instead of at the near-field communications link initiation of step 200. The outside source may be the memory of the device itself (for example, storing a database of assets that may be visited outside mobile data coverage), or, for example, web apps dispatching the mobile device user to carry out a task at a particular asset or directing the user of a shared vehicle service to the location of the vehicle. This device identifier may be combined with the user authentication information collected as in step 202 to accomplish step 204 while the device remains within mobile data coverage, to receive the current access code and the update code in advance of presenting the device to the locking unit. Status updates of step 210 may be delayed from locking or check-out events at the locking device until the mobile device has re-entered an area with mobile data coverage and can once again communicate with the server.

In some embodiments, the process may be coordinated by a geographic information system (GIS), which may supply locking unit asset identifiers and control the timing of access requests. The GIS may be part of the server, or run on other computer hardware that interfaces with the server and the mobile device through data connections. The GIS includes information such as the areas of adequate mobile data signal strength to exchange authentication information and provide access and update codes, the location of assets secured by locking units. The GIS may also query the mobile device for positioning data, such as GPS. The GIS may predict, based on location and movement, which asset or assets a device and its authenticated user may visit that lie outside mobile data coverage. The GIS may use that prediction to select device identifiers from a database and use those device identifiers to make access determinations for the mobile device. The GIS may also use the location data from the mobile device and the geographic data regarding mobile data coverage to coordinate the collection of authentication data of step 202, or the authorization check and provision of current access and update codes of step 204, for example by sending messages to the mobile device to request the authentication information of step 202 when the device is within a certain distance of the edge of coverage, or delaying the transmission of current access and update codes from the server to a mobile device with an authenticated user according to step 204 until the mobile device is about to leave the mobile data coverage area.

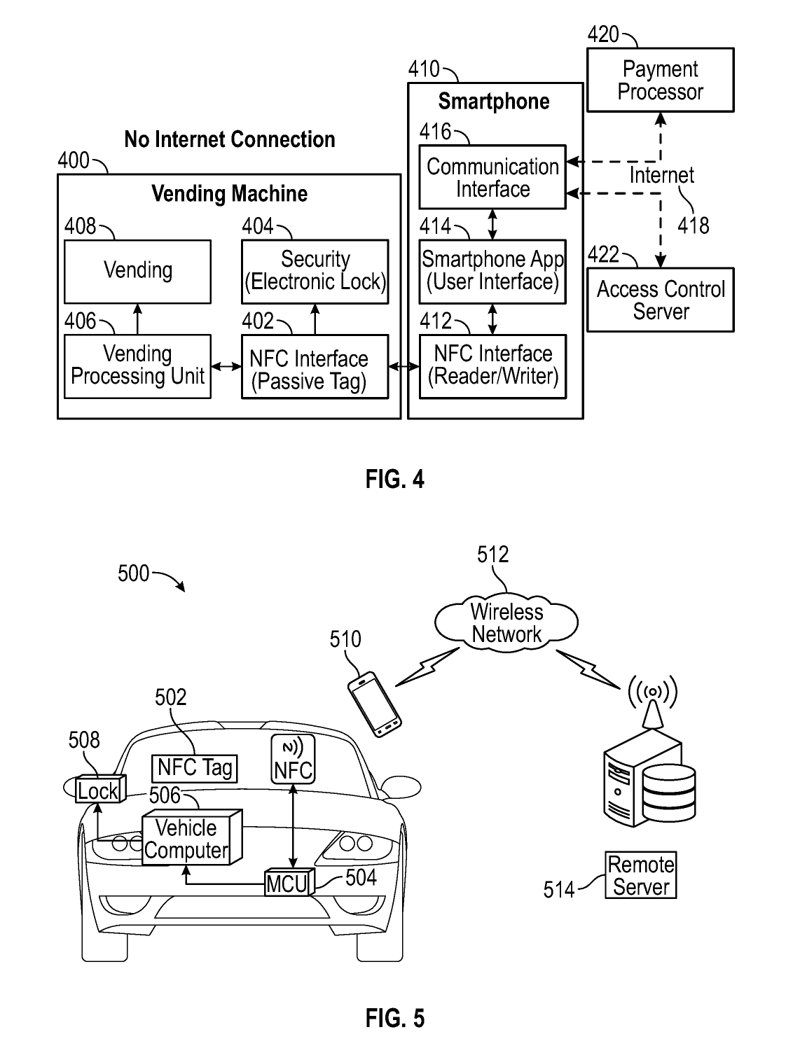

A detailed process flow for an access control request is presented in FIG. 3. Steps for initializing the network and initial deployment are described in steps 302 and 304, with everyday operations described starting in step 304 with user arrival at the secured asset. The mobile unit contacts the locking unit at step 306 and checks in or out according to a determination made in step 308. Authorizations are collected and checked in step 312; if access is denied, steps 314, 316 and 318 allow access attempts to be retried and provide notifications regarding multiple unsuccessful access attempts. If access is granted, steps 320, 322, 324 and 326 are performed to grant access and update the access codes used to grant access at the locking unit.

Initialization for deployment in step 300 includes storing an initial current access code in memory on each locking mechanism for deployment in the field. The locking mechanisms are deployed to control access to particular physical assets, for example controlling the locking of utility cabinets, access through particular doors, or other types of physical access to assets, or controlling the door locks and ignition of a shared vehicle. In this step, a managed application may be installed on mobile devices to be used according to these methods or as part of these systems, the managed application programmed to manage the communications of the device with the server and the locking mechanisms and to collect user authentication information through the mobile device.

The asset and code database is updated in step 302. In this step, following the initialization for deployment, the database is updated to include the asset ID for every locking mechanism deployed in the field, along with the corresponding initial current access codes for the deployed locking mechanisms.

In step 304, a user arrives at the secured access, starting the typical versions of this process in iterations following initial deployment of the locking units. At this point, the user may open a manage application on the mobile device, and optionally, the managed application may collect the user authentication information such as fingerprints, iris scans, account information, or a PIN or password before interacting with a locking unit, to collect and confirm those credentials in advance of an unlocking operation. Optionally, credentials collected ahead of time may be stored in memory on the mobile device to be used at the time of an unlocking request at a locking unit, or may be used to start an authenticated user session where the device is associated with the authenticated user for the duration of the session, with the authentication done on the server and valid for the duration of the session. The credentials may include account or payment information for transactions required during interaction with the secured asset, such as an identifier of an account the user has with a vehicle-sharing service, or mobile payment application information for conducting a transaction with a vending machine. Alternatively, those credentials may be collected at the time of an unlocking request at a particular locking unit.

The mobile device establishes a near-field communications link with the locking unit in step 306, for example by touching the NFC tag of the locking unit with the mobile device. The mobile device may read the locking unit asset identification from the locking unit's NFC tag at this time. In some embodiments, the initiation of the NFC link between the locking unit and the mobile device may signal the locking unit to wake up the microcontroller used to compare access codes and that controls the lock actuator. In addition, energy harvesting by an NFC energy harvesting unit at the locking unit may optionally begin at this time in some embodiments.

In some embodiments, there may be a check-out process as well as a check-in process. In embodiments with a check-out process, the check-in or check-out nature of the contact between mobile device and locking unit is determined in step 308. A check-out versus a check-in may be determined, for example, by referencing the status of the locking mechanism and whether it is currently locked or unlocked, or by querying the mobile device or the server to see whether the locking unit was checked in or checked out most recently, with a process defined as a check-in where the most recent prior process at the locking unit was a check-out, or a check-out where the most recent prior process at the locking unit was a check-in. In those embodiments where a check-out has been determined, a check-out process occurs and the check-out is logged in step 310. Check-outs may include recording a time-stamp for the check-out, overwriting the current access code, actuating the locking mechanism to lock the asset up again, and/or communicating with the server regarding this change in status at the locking unit or communicating sensor readings of lock mechanism and access status, or environmental factors such as temperature at the locking unit. Check-outs may optionally include the transfer of environmental sensor data or operational data from sensors at the locking unit or logging units storing readings from those sensors to the mobile device from the locking unit, and transmission of that sensor data from the mobile device to the server. The operational data may include, for example for shared vehicles, mileage and maintenance data and location data for the vehicle at the end of the use, or for vending machine embodiments, the updated inventory of the vending machine. If the connection between mobile device and locking unit is determined to be a check-in, the method proceeds to step 312 to determine the authorization of the user and device to access the asset of the locking unit at that particular date and time.

Authorization for the user and the device to access the asset at the particular date and time are checked in step 312. The authorization check may be performed, for example by comparing the user authentication information, locking unit asset identification, mobile device identification, and the time and date of the access request against a database of permissions. The database of permissions may include time restrictions on when a user may be allowed access to the secured asset, for example reservations lists for a shared vehicle, or maintenance personnel hours for access to a secured maintenance location such as electrical cabinets or cell towers. Additionally in some embodiments, the authorization may be contingent on a payment, for example for access to an item in a vending machine. Payments may in some embodiments be performed in cash at the secured asset, which is included in the identifier provided by the mobile device, and in some embodiments credit cards or mobile payment apps may be used to initiate a payment transaction on which the authorization check depends. If an appropriate user is requesting access to a locking unit at an appropriate time, the authorization check will come back as a “yes” and the server will proceed to step 320 to provide the user with the proper access code, an update code, and log the check-in. If at least one of the date and time, user authentication, or mobile device authentication do not conform to the set of access rules, the authorization is denied and step 314 is performed to allow another attempt at authorization. The authorization check may proceed through alternative methods, such as first authenticating the user against a separate database of user authentication information before proceeding with the remainder of the authorization check process. The information used by the server in the authorization check process, such as the user authentication information or access rules may be updated dynamically

If access has not been granted, there may be a prompt to retry access 314. Re-trying access may include collecting user authentication information again, for example where a poor scan or improper input of a PIN denies access to a user that has access, and sending the newly collected information along with the locking unit asset identification to the server to retry the authorization check with the updated information. Access may be re-tried several times until a check for repeated failures 316 is satisfied, for example after three or five unsuccessful attempts at access, at which point notification is provided to the user of the mobile device and optionally to technical support for the locking mechanism in step 318. Optionally notifications can also be generated and distributed to security or other personnel, by generating automated messages routed to computers or mobile devices used by those personnel.

In step 320, the server updates a check-in log with the successful current check-in and provides the mobile device with the current access code and an update code. The check-in log tracks which users and devices are attempting to access which locking units at which particular times. The check-in log may be updated with a time-stamp, a locking unit asset identifier, a user identity determined from the user authentication information, and/or a device identification from the mobile device where the access request is transmitted from. The current access code is the access code most recently written into memory at the locking unit and may for example be retrieved from a database storing current access codes according to the locking unit device identifiers, by using the device identifier provided in the access request to look up the appropriate entry. The update code is a code that will replace the current access code and become the next access code at that locking unit. The locking code is preferably generated randomly. The current access code and unlocking code may be encrypted by the server for decryption at the mobile device.

After the mobile device has received the current access code and the update code, the mobile device transmits the current access code to the locking unit via NFC in step 322. If the current access code provided by the mobile device matches the current access code stored in memory at the locking unit, the locking unit provides access to the memory, removing any write protection from the memory at the locking unit. The locking unit gives the mobile device access to the memory where access codes are stored, allowing the mobile device to send the update code to locking unit via NFC in 324. The update code is written over the current access code, replacing it and becoming the current access code for the next unlocking operation to occur at this particular locking unit. Once the update code has replaced the previous current access code, the memory at the locking unit may have its write-protection activated again, protecting the new current access code stored in the memory until another successful unlocking operation at the locking unit.

The locking unit actuates locking mechanism, giving access to the secured asset in step 326. In some embodiments, the actuator for the locking mechanism is a piezoelectric actuator, to minimize power requirements. In some embodiments, the actuator is powered by a power storage device incorporated into the locking unit. In other embodiments, the actuator may be powered by an NFC power harvesting device included in the NFC tag at the locking unit. In some embodiments, the locking unit unlocks the doors and/or ignition of a shared vehicle. The locking unit may also only grant access to one portion of the secured asset, as determined by the identifier and access code, for example allowing access to one door in a vending machine containing the purchased item. In other embodiments, the locking unit may cause an item within the secured asset to be released, such as dropping an item out of a vending machine into an area for pickup by a customer.

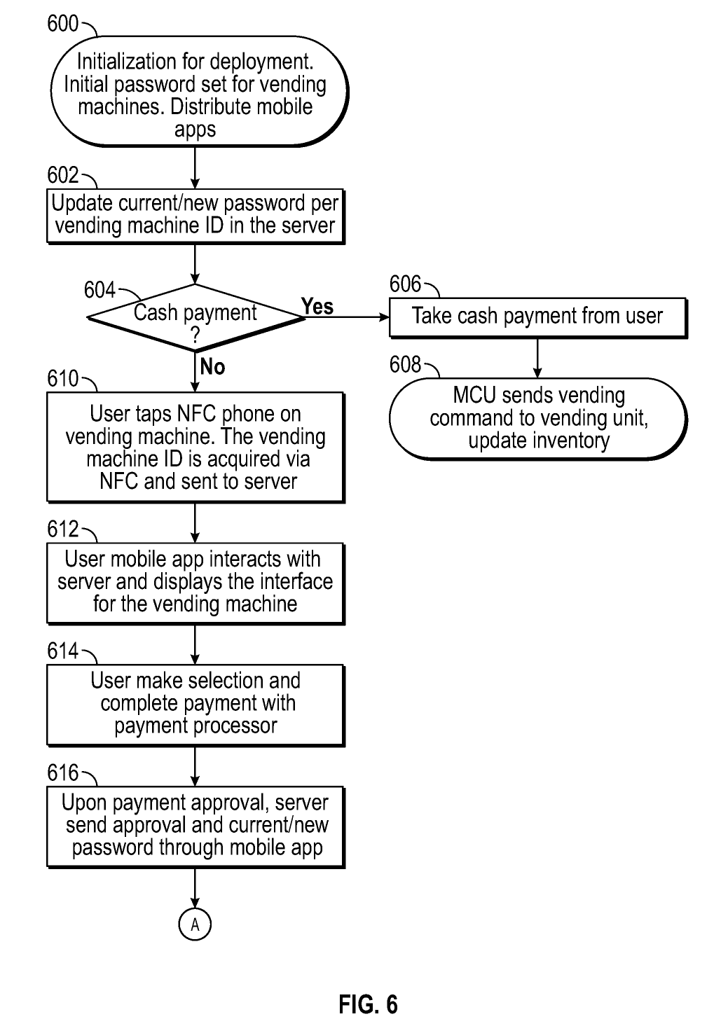

FIG. 4 is a block diagram of a system embodiment of the invention directed towards controlling access to the contents of a vending machine through NFC. The vending machine 400 includes NFC interface 402, Security 404, Vending Processing Unit 406 and Vending 408. The mobile device 410 includes NFC interface 412, a smartphone app 414, and communications interface 416, which connects the mobile device to the internet 418, to access payment processor 420 and access control server 422. The vending machine 400's NFC interface 402 may be a passive NFC tag to provide a device or product identifier to the NFC interface 412 of the mobile device 410. The vending processing unit 406 is a processor configured to receive input from the vending machine interface and the NFC tag and control the vending unit 408 by directing the vending unit 408 to select and present the appropriate item requested from the vending machine 400 upon presentation of the appropriate access code. A memory may be included alongside the processor to store one or more access codes, and the access codes may be single-use codes that are re-written in the memory with each transaction. The vending unit 408 is a mechanism for delivery of items stored within the vending machines, such as standard vending machine components including, for example, a screw dropping a selected product into an accessible portion of the vending machine, gates releasing a product, or belts that move a selected product to an area accessible by the customer. The security 406 may control access to the area where the selected item is accessed by the vending machine customer, for example locking in place a swinging door that a customer reaches into to access the selected item from the vending machine. In some embodiments, security may also control access to the vending machine for restocking, cash collection, and maintenance purposes, allowing selected personnel to present particular access information through the same architecture to enable their access to the inside of the vending machine to perform such tasks.

Smartphone 410 uses NFC interface 412 to communicate with the vending machine 400. NFC interface 412 is a near-field communications antenna which produces a signal that can be picked up by an NFC tag such as NFC interface 402 on the vending machine 400. Smartphone app 414 runs on the processor or processors and utilizes memory on the smartphone 410, and provides a user interface for the input of identifying data and optionally other information such as payment information; the user interface may be presented on the display of the smart phone 410 and the input of the data may be accomplished through components of the smart phone 410 such as a touch-screen or a camera. Communication interface 416 is a wireless data link through which the smartphone 410 is able to access the internet 418. This may include, for example, 3G, 4G, and LTE connections. In some embodiments, other wireless communications technologies such as Wi-Fi (for example, the 802.11 standards), ZigBee or Bluetooth may be used to connect to a device with internet connection to provide access. Via the internet 418, the smartphone 410 connects with the access control server 422 and for some transactions and in some embodiments also connect with payment processor 420. Access control server 422 is a set of processors and memories configured to receive information from the smartphone 410 including a device identifier for the vending machine 400 and user identification data input through the smartphone app 414's user interface to make an access determination, and to generate a new access code for a subsequent interaction with the vending machine 400. The payment processor 420 may be an interface with credit card software or a mobile payment service that initiates transactions in accordance with the request at the vending machine 400 to pay for the selected item if it has not been paid for in cash at the vending machine 400. The payment processor 420 may in some embodiments communicate with the access control server 422 via the internet 418 to confirm payment before an access code is supplied from the access control server 422 to the smartphone 410.

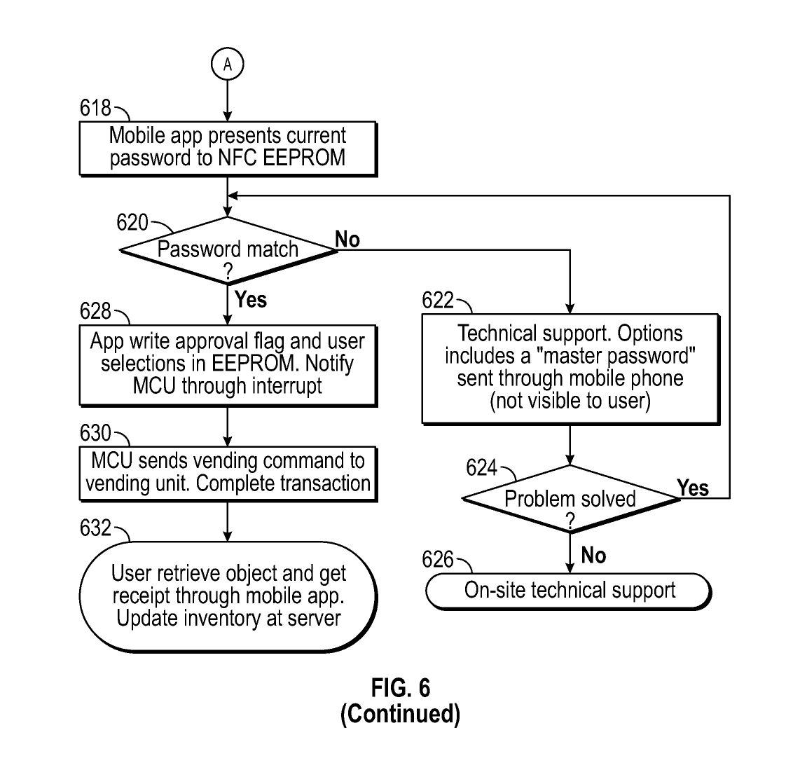

FIG. 5 is a diagram of an embodiment of the invention directed towards controlling access to a shared vehicle. The vehicle 500 is, for this example embodiment, a car. The car features NFC tag 502 for exchanging information with mobile device 510, which is equipped with an NFC antenna. The NFC tag 502 is connected with microcontroller unit (MCU) 504. The NFC tag 502 may include a memory for storing or have a hard-wired device identifier code which may be provided to the mobile device 510 via the NFC communications link. The MCU 504 interfaces with the vehicle computer 506 to control access to the vehicle and its functionality, for example by directing the vehicle computer 506 to actuate the door locks 508, and may additionally or alternatively control the vehicle's ignition and thus the user's ability to operate the vehicle. In some embodiments, the NFC tag 502 also allows the transmission of information from the vehicle computer 506 to the mobile device 510, for example to provide the mobile device with an updated mileage, or to communicate maintenance alerts to the mobile device 510 and to enable the mobile device 510 to communicate the information to the remote server 514.

The MCU 504 may include a processor and a memory. The memory is a non-volatile memory which configured to store a current access code, and the processor is configured to compare the stored current access code to an access code received from the NFC tag 502, and when those codes match, provide a signal to the vehicle computer 506 to grant access to and use of the vehicle, for example by triggering the opening of the vehicle's door locks 508 or allowing the ignition to be operated. The current access code the memory stores may be single-use and be overwritten by a new code received via the NFC tag 502 each time a matching code is provided to the MCU 504 and access is granted accordingly.

Mobile device 510 includes an NFC antenna for communicating with the NFC tag 502. The mobile device also contains processors and memories which run an app presenting a user interface and collecting user identification such as passwords, fingerprints, or iris images information using features of the mobile device such as touch-screens, keypads, fingerprint sensors or cameras. In some embodiments, the mobile device may include a GPS system which provides location data to the app at certain times, for example to provide a vehicle location at the check-out of the vehicle.

Mobile device 510 uses a wireless network 512 to ultimately connect with a remote server 514, to communicate information collected via the app on the mobile device 510 and also information received from the vehicle 500 via the NFC tag 502. The information communicated may include a device identifier for the vehicle 500 and the user information during an unlocking process for the vehicle 500. The wireless network may be an internet connection initially accessed through wireless means such as 3G, 4G or LTE cellular data communications or may, in some embodiments, connect through other wireless communication methods such as the 802.11 standards and using a Wi-Fi connection to a network that is connected to the internet. The remote server 514 is a set of processors and memories configured to process access requests received via the wireless network, by using the device identifier and user information provided by mobile device 510 and a database of access permissions to determine whether the user can access the vehicle at this time. The database of access permissions may, for example, be a list of approved users or a reservation schedule for particular users to have access to particular vehicles, as well as reference information to confirm the user information such as storing the user's password, fingerprint, or iris image for comparison by the processors of the remote server 514. If the processors of remote server 514 determine that a user is allowed access, it retrieves the current access code for the vehicle 500 and generates a next access code for that vehicle. The current and next access codes are communicated by wireless network 512 to mobile device 510, which communicates the current access code to the NFC tag 502, and if the access code provides the, the current access code stored in the memory at MCU 504 is overwritten with the next access code provided by the mobile device 510. In some embodiments, the remote server 514 also communicates with the mobile device 510 during a check-out process when the user has completed their use of the vehicle. This may include the mobile device confirming the end of the use, and additionally providing the server with data which may include the location of the check-out as determined by GPS by the mobile device 510, the vehicle mileage and/or maintenance alerts, which may be supplied by the vehicle computer 506 to the mobile device 510 via NFC tag 502, then communicated from the mobile device 510 to the remote server 514 via the wireless connection 512. In some embodiments these steps may be performed in different orders or with delays between the steps to account for inability of the mobile device 510 to access the wireless network 512, for example by confirming the user identity and providing the access code to the mobile device 510 prior to establishing a connection between the mobile device 510 and NFC tag 502, or by delaying communications following check-out procedures by collecting the GPS and vehicle computer 506 data at the time of check-out, but storing that information in memory until a wireless connection 512 can be established to provide that data to the remote server 514.

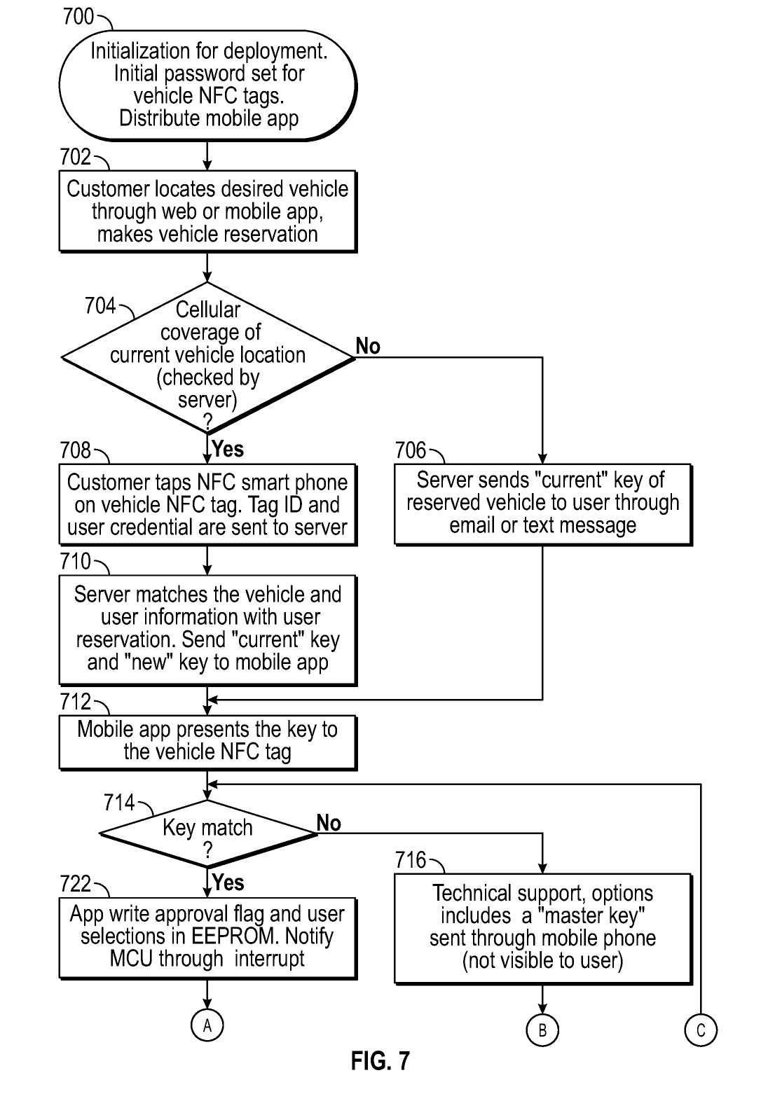

FIG. 6 is a flow diagram for an access request for a vending machine. The device is initialized in step 600, with an initial access code programmed into a memory of the vending machine access unit. Optionally, other access codes may be stored in memory to serve as a backup or a master password to enable access where there are problems with the standard access method described here. The initial access code may be updated prior to a particular transaction as shown in step 602, for example by iterations of the access request process after initialization but prior to this example access request. The process for the access request may proceed differently based on the decision point 604, whether the payment will be performed locally in cash, or if the payment will be made using the mobile device. For cash transactions, the cash payment is provided by the user 606 and a microcontroller in the vending machine access unit instructs the vending machine to provide the selected and paid-for item in step 608. Optionally, in step 608, inventory data for the vending machine is updated to account for the completed transaction.

If the payment is to be performed using the mobile device, the process proceeds from decision point 604 to step 610, where the user brings the mobile device into close proximity of the vending machine access unit, for example by the user tapping the mobile device against a near-field communications (NFC) tag, and an NFC link is established between the mobile device and the vending machine, through which the mobile device receives a device identifier from the vending machine. The mobile device, in turn, uses a wireless communication network such as cellular (for example 3G or LTE) or Wi-Fi (for example one of the 802.11 networking standards) to connect to a remote server and provide the server with the device identifier from the vending machine. In step 612, the mobile device may receive information about the vending machine from the server and present vending options within a user app. The user app may provide an interface for selecting a payment method and may, in some embodiments present an interface for selecting an item from the vending machine. Through the app or through interaction with the vending machine, the user makes a selection, and through the app the user completes a payment in step 614. The payment may be completed by providing payment information such as credit card information, and optionally user identification information to a payment processor, or by using an existing mobile payment infrastructure such as Apple Pay. When the payment has completed, step 614 ends. In step 616, the server receives the payment confirmation, either from the mobile device or from the payment processor, and based on the device identifier from the vending machine, and the item selection from the user app on the mobile device or at the vending machine, the server references a database of unlock codes and selects the appropriate unlock code as well as an update unlock code and transmits those codes to the mobile device. The update unlock code may be generated during this step, for example by generating a random string having a defined length. In step 618, the mobile device transmits the unlock code to the vending machine via the NFC connection, where it is stored in a memory such as EEPROM at the vending machine. A processor at the vending machine compares the received unlock code to a stored unlock code in step 620, proceeding either to step 622 if the received and stored unlock codes do not match, or to step 628 if the stored unlock and lock codes match.

In step 622, which occurs when the received and stored unlock codes do not match, there may be an automatic intervention to resolve the issue. One example of an issue that may trigger step 622 is where there was a failure in a prior updating of the access code. In one example of step 622, the mobile device communicates the failure to match unlock codes with the server, which provides a master password to the mobile device, which then presents the master password to the vending machine, this master password matching a second access code stored in memory at the vending machine and allowing the vending machine to proceed to step 628 via step 620. The effectiveness of the automated step 622 may be evaluated in step 624. In cases where step 622 succeeded, the process returns to step 620 to proceed to step 628. Where step 622 does not succeed, the process ends with step 626, where a notification is provided to local technical support personnel to request a maintenance visit to the vending machine, which may, for example be identified and the location provided to the maintenance personnel using the device identifier transmitted to the server in step 610.

In step 628, which occurs when the received and stored unlock codes match, the mobile app on the mobile device, through the NFC link, writes an approval flag in the EEPROM and may write in the selection of the item selected from the vending machine. Step 628 also triggers an interrupt at the microcontroller unit (MCU). The MCU at the vending machine then reads the approval flag in step 630 and directs the vending machine to provide the selected item, for example by having a screw turn that drives the item to be dropped into an accessible part of the vending machine. Optionally, in step 630, the vending machine may allow the mobile phone to overwrite the current access code with the update access code that it received from the server in step 616. Once the item has been vended, in step 632, there may optionally be a check-out procedure, for example transmitting inventory information stored in memory at the vending machine to the mobile device via the NFC link, and the mobile device using the wireless communications network to then communicate the inventory information to the server. The inventory information may be a matrix storing the number of each item still remaining in the vending machine.

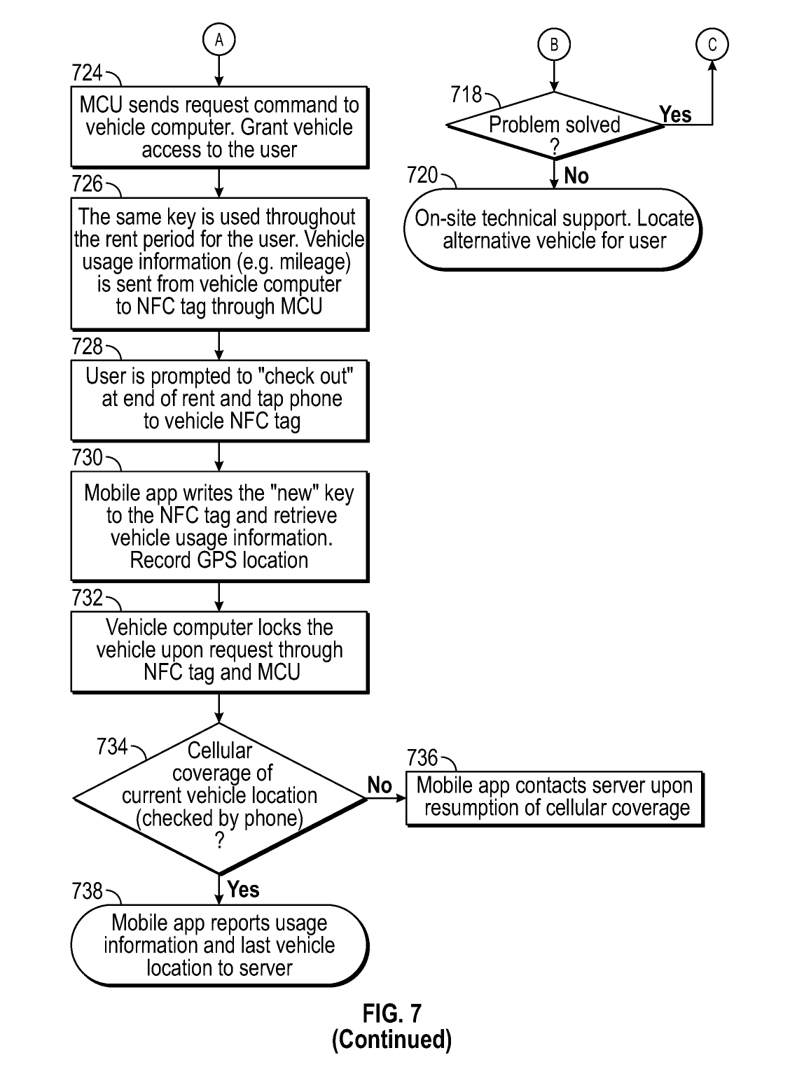

FIG. 7 depicts an example process for controlling access to a shared vehicle such as an automobile. In step 700, the access control device at the vehicle is initialized, including storing an initial access code in memory. Optionally, additional information may be stored in memory at the access control device such as a master password for use in case the standard access method fails.

The process for an individual access request to a shared vehicle begins with a user reservation of the vehicle in step 702. The reservation may be made, for example, using a website or a mobile app. The reservation must include a user identification, a vehicle identification for the shared vehicle to be accessed, and a starting time for the reservation, and the reservation is stored in a database accessible by server.

Based on the user reservation, it is determined whether or not the shared vehicle is within range of a wireless connection usable by the mobile device (e.g. a cellular connection such as 3G or LTE, or a known wireless network such as one according to the 802.11 protocols) in step 704. This is determined at the server, by comparing the identifier of the reserved vehicle to a database of vehicle locations by identifier, which may cross-reference, for example, the recorded GPS coordinates where the shared vehicle is located with a map of cellular coverage to make the determination of the network accessibility at the shared vehicle. This determination may be made at the last check-out involving the selected shared vehicle prior to the reservation or at any point following that check-out.

If the shared vehicle is outside of wireless connection coverage for the mobile device, the method proceeds to step 706, where the access code for the vehicle and optionally an update access code are provided to the mobile device in advance of the mobile device being in proximity with the shared vehicle, so that the mobile device may receive the information while it is connected to a wireless connection. The access code is retrieved based on the vehicle identifier associated with the reservation made in step 702. The information may be sent to the mobile device user via email or text message such as SMS, or may be sent to the mobile device through a user app on the mobile device. The access code and additional information are stored in the mobile device until step 712.

Where it is determined in step 704 that a wireless connection is available to the mobile device at the location of the shared vehicle, the process moves to step 708, once the user is in proximity to the shared vehicle. At the shared vehicle, the user presents the mobile device to the vehicle, for example tapping or pressing their mobile device against a near-field communications (NFC) tag on the vehicle. This causes the mobile device and the access unit for the shared vehicle to be connected by an NFC link, through which the access unit for the shared vehicle provides the mobile device with a device identifier for the shared vehicle. The mobile device completes step 708 by providing the device identifier and user information to the server. The user information may include the identity of the user such as a name or an account identifier, or may include authentication information such as passwords or biometric information, such as fingerprints captured with a sensor on the mobile device or iris images captured via a camera on the mobile device. The user information and the device information received by the server are used to determine access to the vehicle in step 710, by having the server compare the user identification, the device information, and the current time to a database recording the reservations made in step 702. Optionally, this may also include authenticating the user and verifying their identity through the authentication information. If the user, device identifier and time of the request are in compliance with the database of reservations, step 710 is completed by providing a current access code and an update access code from the server to the mobile device. The update access code may be generated during step 710, for example by generating a random string of a predetermined length.

The mobile device provides the current access code to the access unit of the shared vehicle via an NFC link in step 712, and a processor in the access unit determines whether or not the current access code that has been presented matches an access code stored in memory at the access unit in step 714. Where the current access code does not match the stored access code, remedial actions may be taken in step 716, and where the access codes do match, the process proceeds to step 722.

If the provided access code does not match the access code stored in memory at the access unit, automated technical support is tried in step 716, for example by the server providing a master password to the mobile device and in turn providing that master password from the mobile device to the access unit. The master password may be programmed into the access unit during the initialization of step 700. This process may not inform the user of its occurrence, to prevent the user from becoming aware of the error. If the master password provided by the mobile device matches the master password stored at the access unit, this may be identified in step 718 and the process may proceed to step 722 where an approval flag is written into a memory at the access unit. If in step 718 it is determined that there is still a key mismatch or another failure, the process moves to step 720 where on-site maintenance personnel are informed of the failure, for example by an automated email or text message. The automated message may include location information retrieved by the server based on a database of vehicle identifiers and their locations at check-out. Additionally, the server may search the database of vehicle locations and reservation information to identify nearby available vehicles, and provide the location of the available vehicle to the mobile device user via automated email, text, or via a user app on the mobile device.

In step 722, the matching of the access codes causes an approval flag to be written into a memory such as EEPROM at the access unit. Step 722 also triggers the microcontroller unit (MCU) at the access unit to carry out step 724 by sending an unlock request to the vehicle computer of the shared vehicle. The unlock request triggers one or more actions that grant the user access to the shared vehicle, such as opening the door locks on the vehicle or enabling the vehicle's ignition to be operated.

The access code may be used for the duration of the reservation of the shared vehicle, as noted in 726, until a check-out is initiated in step 728. The vehicle computer may provide information, such as mileage information or maintenance alerts, to the MCU of the access unit either continuously during the reservation or during the check-out that is initiated in step 728, and this data may be transmitted from the MCU to the mobile device via the NFC connection. The check-out procedure begins with step 728, where the user is prompted to check out by pressing or tapping the mobile device against the NFC tag of the vehicle to establish the NFC connection. In step 730, the update code stored in memory at the mobile device is used to overwrite the access code stored in memory at the access unit on the shared vehicle. This may be done by enabling the mobile device to access the memory on the access unit via the NFC connection. Also in step 730, the mobile device retrieves information from the vehicle computer via the NFC connection and the MCU of the access unit to record usage information such as mileage, and optionally any maintenance alarms. Step 730 also includes recording location data for the check-out, such as GPS coordinates determined using the mobile device. In step 732, access to the vehicle is ended, by having the MCU of the access unit instruct the vehicle computer to perform actions to reverse the access grant of step 724, for example by locking vehicle doors and/or disabling the ignition. Once access to the vehicle has ended, the mobile device determines whether it currently has access to a wireless communication network in step 734. The wireless network may be cellular (e.g. LTE) or a wireless network (e.g. 802.11) that provides access to the server, for example via an internet connection. If a wireless connection is available, the mobile device uses the wireless network to provide the location of the shared vehicle and the information such as mileage and/or maintenance alerts to the server in step 738. Alternatively, if the mobile device is not connected to a network at check-out, the vehicle location and information such as mileage and/or maintenance alerts are stored in memory in step 736 and the mobile device periodically checks for a connection, providing the location and information to the server when it detects that a connection is available, for example by checking for a connection on a periodic basis, or having an interrupt occur when the mobile device detects a connection.

1. A method for accessing a secured physical location, comprising:
receiving an asset identification on a mobile device,
collecting user authentication information at the mobile device,
transmitting the user authentication information and the asset identification from the mobile device to a server,
comparing the user authentication information and the asset identification to a set of access rules,
retrieving an unlock code based on the access rules and the asset identification,
generating an update code at the server,
transmitting the unlock code and update code from the server to the mobile device,
transmitting the unlock code from the mobile device to a locking unit,
at the locking unit, comparing the unlock code to a stored code in a memory at the locking unit,
actuating a locking mechanism at the locking unit,
transmitting the update code from the mobile device to the locking unit, and
replacing the unlock code with the update code in a memory at the locking unit.

2. The method of claim 1, wherein the unlock code is transmitted from the mobile device to the locking unit via near-field communications.

3. The method of claim 1, further comprising the locking unit harvesting power from the mobile device via near-field communications, and wherein the lock mechanism is actuated using the harvested power.

4. An access control system, comprising:
a locking unit, comprising:
a communications interface,
a memory configured to store a current access code,
a processor configured to compare the current access code to a received access code, and
an actuator operating a lock
a mobile interface device, comprising:
a communications interface,
a wireless communications link to a mobile access network
a user authentication data collector, and
a server, comprising:
a memory configured to store a database of locking unit asset identifiers and current access codes,
a memory configured to store a database of mobile interface device and user authentication credentials,
a processor configured to determine access authorization based on user authentication credentials and locking unit asset identifiers, and
a processor configured to generate access codes.

5. The access control system of claim 4, wherein the communications interface is near-field communications.

6. A method for interacting with a locking unit using a mobile device, comprising:
on a mobile device, receiving a locked asset identifier,
establishing a communications interface with a locking unit,
collecting user authentication data at the mobile device,
transmitting the user authentication data and the locked asset identifier from the mobile device via a mobile access network,
receiving an unlock code and an update code via a mobile access network, and
transmitting the unlock code and the update code to the locking unit through the communications interface.

7. The method of claim 6, wherein the communications interface is near-field communications.

8. A method for accessing a secured shared vehicle, comprising:
receiving an asset identification on a mobile device,
collecting user authentication information at the mobile device,
transmitting the user authentication information and the asset identification from the mobile device to a server,
comparing the user authentication information and the asset identification to a set of access rules,
retrieving an unlock code based on the access rules and the asset identification,
generating an update code at the server,
transmitting the unlock code and update code from the server to the mobile device,
transmitting the unlock code from the mobile device to a locking unit, comparing the unlock code to a stored code in a memory at the locking unit, using a processor in the shared vehicle,
actuating a locking mechanism in the shared vehicle,
transmitting the update code from the mobile device to the shared vehicle, and
replacing the unlock code with the update code in a memory within the shared vehicle

9. The method of claim 8, further comprising:
receiving, at the locking unit, checkout data from a vehicle computer transmitting, via a near-field communications link, checkout data from the locking unit to the mobile device, and
transmitting the checkout data from the mobile device to the server.

10. A method for operating a vending machine, comprising:
receiving, on a mobile device, an asset identification from a vending machine access unit,
transmitting the asset identification from the mobile device to a server,
receiving, at the server, a payment confirmation for an item in a vending machine
retrieving an unlock code based on the payment confirmation and the asset identification,
generating an update code at the server,
transmitting the unlock code and update code from the server to the mobile device,
transmitting the unlock code from the mobile device to a vending machine access unit,
at a processor in the vending machine access unit, comparing the unlock code to a stored code in a memory at the locking unit,
providing access to an item purchased from the vending machine,
transmitting the update code from the mobile device to the vending machine access unit, and
replacing the unlock code with the update code in a memory at the shared vehicle

11. A shared vehicle access control system, comprising:
a locking unit in a shared vehicle, comprising:
a communications interface,
a current access memory configured to store a current access code,
an access control processor configured to compare the current access code to a received access code, and
an actuator operating a security device
a mobile interface device, comprising:
a communications interface,
a wireless communications link to a mobile access network
a user authentication data collector, and
a server, comprising:
an asset identifier memory configured to store a database of locking unit asset identifiers and current access codes,
an authentication memory configured to store a database of mobile interface device and user authentication credentials,
an access determination processor configured to determine access authorization based on user authentication credentials and locking unit asset identifiers, and
a code generation processor configured to generate access codes.

12. The access control system of claim 11, wherein the locking unit further comprises an interface with a vehicle computer.

13. An access control system for a vending machine, comprising:
a vending machine access unit, comprising:
a communications interface,
a current access code memory configured to store a current access code,
a unit identifier memory configured to store a vending machine access unit identifier,
an access determination processor configured to compare the current access code to a received access code, and
an actuator controlling the delivery of an item in a vending machine,
a mobile interface device, comprising:
a communications interface,
a wireless communications link to a mobile access network, and
a server, comprising:
an access code memory configured to store a database of vending machine access unit identifiers and current access codes,
an authentication memory configured to store a database of mobile interface device and user authentication credentials,
an authorization processor configured to determine access authorization to the vending machine access unit based vending machine access unit identifiers and a payment confirmation, and
a code generation processor configured to generate access codes.

14. The access control system of claim 13, wherein the server further comprises a payment initiation processor configured to receive the payment information and initiate a transaction with a payment processor based on the payment information.

15. The access control system of claim 13, wherein the server further comprises a communications interface with a payment processor.
